(19) United States
(12) Patent Application Publication
(10) Pub. No.: US 2011/0256458 A1
(43) Pub. Date: Oct. 20, 2011

(54) Non-Aqueous Electrolyte Secondary Battery

(75) Inventor: Satoshi Tani, Kyoto-Fu (JP)

(73) Assignee: Murata Manufacturing Co., Ltd.

(21) Appl. No.: 13/170,652

(22) Filed: Jun. 28, 2011

Related U.S. Application Data
(63) Continuation of application No. PCT/JP2009/007157, filed on Dec. 24, 2009.

(30) Foreign Application Priority Data
Jan. 6, 2009 (JP) 2009-000849

(51) Int. Cl. H01M 10/056; H01M 10/05

(52) U.S. Cl. 429/338; 429/188; 429/199; 429/200; 429/342

(57) ABSTRACT

A non-aqueous electrolyte secondary battery which includes a non-aqueous electrolyte solution containing a non-aqueous solvent and an electrolyte, at least two types of lithium salts with an oxalato complex as an anion are contained in the non-aqueous electrolyte solution. The two types of lithium salts are, as an example, lithium bis(oxalate)borate (Li[B(C₂O₄)₂]) and lithium difluoro(bisoxalato)phosphate (Li[PF₂(C₂O₄)₂]).

### CROSS REFERENCE TO RELATED APPLICATIONS

The present application is a continuation of International Application No. PCT/JP2009/007157, filed Dec. 24, 2009, which claims priority to Japanese Patent Application No. JP2009-000849, filed Jan. 6, 2009, the entire contents of each of these applications being incorporated herein by reference in their entirety.

### FIELD OF THE INVENTION

The present invention generally relates to a non-aqueous electrolyte secondary battery including a non-aqueous electrolyte solution containing a non-aqueous solvent and an electrolyte, and more particularly, to a non-aqueous electrolyte secondary battery with the improved composition of an additive to a non-aqueous electrolyte solution.

### BACKGROUND OF THE INVENTION

Conventionally, non-aqueous electrolyte secondary batteries use, for example, a non-aqueous electrolyte solution which has a lithium salt such as lithium hexafluorophosphate dissolved as an electrolyte in a non-aqueous solvent such as dimethyl carbonate. This non-aqueous electrolyte solution has various types of additives contained in order to improve battery characteristics.

For example, Japanese Patent Application Laid-Open No. 2007-165125 (hereinafter, referred to as Patent Document 1) proposes an electrolyte solution for non-aqueous electrolyte batteries and a non-aqueous electrolyte battery for the improvement of durability such as cycle characteristics and high-temperature storage properties and for the suppression of increase in internal resistance for usability in power applications. This electrolyte solution for non-aqueous electrolyte batteries refers to an electrolyte solution for non-aqueous electrolyte batteries, which includes a non-aqueous organic solvent and a solute, and contains, as additives, at least one compound selected from the first group of compounds consisting of bis(oxalato)borates, difluoro(oxalato)borates, tris(oxalato)phosphates, difluoro(bisoxalato)phosphates, and tetrafluoro(oxalato)phosphates and at least one compound selected from the second group of compounds consisting of monofluorophosphates and difluorophosphates.
Patent Document 1: Japanese Patent Application Laid-Open No. 2007-165125

### SUMMARY OF THE INVENTION

Patent Document 1 discloses the use of the combination of one lithium salt with an oxalato complex as an anion and one fluorophosphate as additives to the electrolyte solution for non-aqueous electrolyte batteries, thereby allowing the improvement in capacity retention rate after the repetition of a charge/discharge cycle test at a high temperature and allowing the suppression of increase in internal resistance and of gas generation.

However, the use of the additives disclosed in Patent Document 1 has a limitation in the improvement in capacity retention rate after the repetition of a charge/discharge cycle at a high temperature in the case of a non-aqueous electrolyte battery.

In addition, Patent Document 1 fails to specifically disclose any examples of a non-aqueous electrolyte secondary battery using two types of lithium salts with an oxalato complex as an anion, and fails to make any evaluations on the capacity retention rate after the repetition of a charge/discharge cycle test at a high temperature in such examples.

Therefore, an object of the present invention is to provide, in the case of a non-aqueous electrolyte secondary battery including a non-aqueous electrolyte solution containing a non-aqueous solvent and an electrolyte, the composition of an additive to the non-aqueous electrolyte solution for the improvement of the capacity retention rate after the repetition of a charge/discharge cycle at a high temperature.

The non-aqueous electrolyte secondary battery according to the present invention provides a non-aqueous electrolyte secondary battery including a non-aqueous electrolyte solution containing a non-aqueous solvent and an electrolyte, wherein at least two types of lithium salts with an oxalato complex as an anion are added to the non-aqueous electrolyte solution.

The non-aqueous electrolyte secondary battery according to the present invention, in which at least two types of lithium salts with an oxalato complex as an anion are added to the non-aqueous electrolyte solution, can thus improve the capacity retention rate after the repetition of a charge/discharge cycle at a high temperature, that is, the high-temperature cycle characteristics.

In the non-aqueous electrolyte secondary battery according to the present invention, the at least two types of lithium salts are preferably Li[M(C₂O₄)ₓR_{y}] (in the formula, M is one selected from the group consisting of P, B, Al, Si, and C; R is one group selected from the group consisting of a halogen group, an alkyl group, and a halogenated alkyl group; x is a positive integer; and y is 0 or a positive integer).

In the non-aqueous electrolyte secondary battery according to the present invention, the two types of lithium salts are preferably:

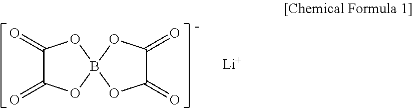

lithium bis(oxalate)borate (Li[B(C₂O₄)₂]); and

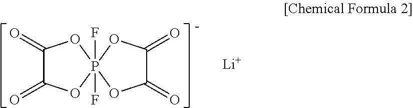

lithium difluoro(bisoxalato)phosphate (Li[PF₂(C₂O₄)₂]).

Also, in the non-aqueous electrolyte secondary battery according to the present invention, lithium bis(oxalate)borate and lithium difluoro(bisoxalato)phosphate are added respectively at 0.3 parts by weight or more and 3.0 parts by weight or less and at 0.3 parts by weight or more and 2.0 parts by weight or less to 100 parts by weight of the non-aqueous electrolyte solution.

Furthermore, in the non-aqueous electrolyte secondary battery according to the present invention, lithium bis(oxalate)borate and lithium difluoro(bisoxalato)phosphate are added respectively at 0.5 parts by weight or more and 1.5 parts by weight or less and at 0.5 parts by weight or more and 1.0 parts by weight or less to 100 parts by weight of the non-aqueous electrolyte solution.

In this case, the high-temperature cycle characteristics can be further improved.

As described above, according to the present invention, the composition of an additive to the non-aqueous electrolyte solution for the improvement of the capacity retention rate after the repetition of a charge/discharge cycle at a high temperature can be provided in the case of the non-aqueous electrolyte secondary battery including the non-aqueous electrolyte solution containing the non-aqueous solvent and the electrolyte.

### DETAILED DESCRIPTION OF THE INVENTION

The present inventor has made a great deal of consideration in various ways on the compositions of additives to a non-aqueous electrolyte solution for the improvement of the capacity retention rate after the repetition of a charge/discharge cycle at a high temperature. As a result, the present inventor has found that when at least two types of lithium salts with an oxalato complex as an anion are used and added to a non-aqueous electrolyte solution, the capacity retention rate can be improved after the repetition of a charge/discharge cycle at a high temperature. The present invention has been achieved on the basis of this finding of the present inventor.

In a non-aqueous electrolyte secondary battery according to the present invention, the two types of lithium salts are, as an example:

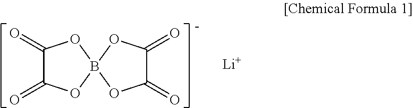

lithium bis(oxalate)borate (Li[B(C₂O₄)_{2]}); and

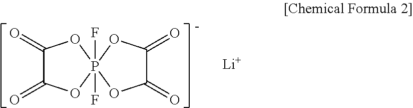

lithium difluoro(bisoxalato)phosphate (Li[PF₂(C₂O₄)₂]).

Preferably, for the two types of lithium salts mentioned above, the lithium bis(oxalate)borate and the lithium difluoro(bisoxalato)phosphate are added respectively at 0.3 parts by weight or more and 3.0 parts by weight or less and at 0.3 parts by weight or more and 2.0 parts by weight or less to 100 parts by weight of the non-aqueous electrolyte solution.

In addition, preferably, the lithium bis(oxalate)borate and the lithium difluoro(bisoxalato)phosphate added respectively at 0.5 parts by weight or more and 1.5 parts by weight or less and at 0.5 parts by weight or more and 1.0 parts by weight or less to 100 parts by weight of the non-aqueous electrolyte solution can thereby further improve the capacity retention rate after the repetition of a charge/discharge cycle at a high temperature.

In one embodiment of the present invention, the non-aqueous electrolyte secondary battery includes: a non-aqueous electrolyte solution with an electrolyte dissolved in a non-aqueous solvent; a positive electrode; and a negative electrode.

As the non-aqueous solvent described above, dimethyl carbonate, ethylmethyl carbonate, ethylene carbonate, propylene carbonate, butylene carbonate, diethyl carbonate, etc. can be used by themselves, or two or more thereof can be used in combination. Furthermore, the non-aqueous solvent may contain chain esters such as methyl formate, ethyl formate, methyl acetate, and ethyl acetate; cyclic esters such as γ-butyrolactone; and cyclic sulfones such as sulfolane.

In addition, as the electrolyte described above, LiPF₆, LiAsF₆, LiBF₄, LiCF₃SO₃, LiC(SO₂CF₃)₃, LiN(SO₂C₂F₅)₂, LiN(SO₂CF₃)₂, etc. can be used by themselves, or two or more thereof can be used in combination.

Furthermore, the positive electrode and the negative electrode are arranged to be stacked alternately with a separator interposed therebetween. The structure of the battery element may be composed of a laminate which has a plurality of strip-like positive electrodes, a plurality of strip-like separators, and a plurality of strip-like negative electrodes, that is, a laminate which has a so-called stacked structure, or may be composed of an elongated separator in a zigzag arrangement with strip-like positive electrodes and strip-like negative electrodes interposed alternately. Alternatively, a coiled structure obtained by coiling an elongated positive electrode, an elongated separator, and an elongated negative electrode may be adopted as the structure of the battery element. In the following examples, the coiled structure is adopted as the structure of the battery element.

The positive electrode is formed by stacking a positive electrode active material on both surfaces of a positive electrode current collector. As an example, the positive electrode current collector is composed of aluminum. For the positive electrode active material, a composite oxide of lithium cobalt oxide (LCO), a composite oxide of lithium manganese oxide (LMO), a composite oxide of lithium nickel oxide (LNO), a lithium-nickel-manganese-cobalt composite oxide (LNMCO), a lithium-manganese-nickel composite oxide (LMNO), a lithium-manganese-cobalt composite oxide (LMCO), a lithium-nickel-cobalt composite oxide (LNCO), etc. can be used. Furthermore, the positive electrode active material may be a mixture of the materials mentioned above. The positive electrode active material may be an olivine based material such as LiFePO₄.

On the other hand, the negative electrode is formed by stacking a negative electrode active material on both surfaces of a negative electrode current collector. As an example, the negative electrode current collector is composed of copper, whereas the negative electrode active material is composed of a carbon material. Graphite, hard carbon, soft carbon, etc. are used as the carbon material of the negative electrode active material. In addition, the negative electrode active material may be a mixture of the materials mentioned above. The negative electrode active material may be a ceramic such as lithium titanate or an alloy based material such as Si and Sn.

The separator is not to be considered limited particularly, and conventionally known separators can be used. It is to be noted that in the present invention, the separator is not to be considered limited by its name, and a solid electrolyte or a gel electrolyte which functions (serves) as a separator may be used in place of the separator. Alternatively, a separator may be used which contains an inorganic material such as alumina or zirconia.

### Examples

With the use of a positive electrode, a negative electrode, and a non-aqueous electrolyte solution prepared as described below, non-aqueous electrolyte secondary batteries according to Examples 1 to 11 and Comparative Examples 1 to 7 were produced by varying the composition of the additives to the non-aqueous electrolyte solution as shown in Table 1 below.

(Preparation of Positive Electrode)

A lithium-nickel-manganese-cobalt composite oxide (LNMCO) represented by the composition formula LiNi_{1/3}Mn_{1/3}Co_{1/3}O₂ as a positive electrode active material, carbon as an electrical conduction aid, and polyvinylidene fluoride (PVDF) as a binder were compounded at 90:7:3 in terms of ratio by weight, and mixed and kneaded with N-methyl 2-pyrrolidone (NMP) to produce a slurry. This slurry was applied to both surfaces of an aluminum foil as a current collector, dried, and then subjected to rolling by roll press, thereby producing a positive electrode.

(Preparation of Negative Electrode)

Natural graphite powder as a negative electrode active material and PVDF as a binder were compounded at 95:5 in terms of ratio by weight, and mixed and kneaded with NMP to produce a slurry. This slurry was applied to both surfaces of a copper foil as a current collector, dried, and then subjected to rolling by roll press, thereby producing a negative electrode.

(Preparation of Non-Aqueous Electrolyte)

The solvent was prepared by preparing dimethyl carbonate (DMC), ethylmethyl carbonate (EMC), and ethylene carbonate (EC) at 1:1:1 in terms of ratio by volume. Lithium hexafluorophosphate (LiPF₆) as an electrolyte was dissolved at a ratio of 1 mol/L in this solvent to produce a non-aqueous electrolyte solution.

To 100 parts by weight of the obtained non-aqueous electrolyte solution, lithium bis(oxalate)borate (Li[B(C₂O₄)₂]) and lithium difluoro(bisoxalato)phosphate (Li[PF₂(C₂O₄)₂]) were added in accordance with parts by weight shown in Table 1 to prepare a non-aqueous electrolyte solution containing the additives.

(Preparation of Battery)

The positive electrode and negative electrode prepared as described above were provided with a lead tab. The positive electrode and negative electrode with a porous separator interposed therebetween was coiled in a flattened shape, and housed in a wrapping material composed of a laminate film containing aluminum as an intermediate layer. After that, the non-aqueous electrolyte solution prepared as described above was injected into the wrapping material, and the opening of the wrapping material was subjected to sealing, thereby producing a non-aqueous electrolyte secondary battery with a battery capacity of 260 mAh.

The non-aqueous electrolyte secondary batteries obtained in the way described above according to Examples 1 to 11 and Comparative Examples 1 to 7 were used to measure the following characteristics. The measurement results are shown in Table 1.

(Measurement of Initial Discharge Capacity)

Each battery was charged with a charging current of 75 mA until the voltage reached 4.2 V, and further charged until the charging current reached 12.5 mA while reducing the charging current with the voltage kept at 4.2 V. Then, the initial discharge capacity was measured in the case of discharging each battery with a discharging current of 250 mA until the voltage reached 2.5 V.

(High-Temperature Cycle Characteristics)

As high-temperature cycle characteristics, the capacity retention rate was measured after the repetition of a charge/discharge cycle 100 times at a temperature of 60° C. Specifically, each battery was charged with a charging current of 500 mA under an atmosphere at a temperature of 60° C. until the voltage reached 4.2 V, and further charged until the charging current reached 12.5 mA while reducing the charging current with the voltage kept at 4.2 V. Then, the discharge capacity was measured in the case of discharging each battery with a discharging current of 500 mA until the voltage reached 2.5 V. This charge/discharge defined as 1 cycle was repeated 100 times. The rate of the discharge capacity measured after 100 cycles to the discharge capacity measured after 1 cycle was calculated in accordance with the following formula, and the obtained value was evaluated as the capacity retention rate (%) after 100 cycles.

Capacity Retention Rate (%)={(Discharge Capacity after 100 Cycles)/(Discharge Capacity after 1 Cycle)}×100

TABLE 1

| | | | Function Effects | | | | |
|---|---|---|---|---|---|---|---|
| | | | Initial | | High-Temperature Cycle | | |
| | Electrolyte | | Characteristics | | Characteristics | | |
| | LiB | LiPF₂ | Initial | | Capacity Retention | | |
| | (C₂O₄)₂ | (C₂O₄)₂ | Discharge | | Rate after | | Comprehen- |
| | (parts by | (parts by | Capacity | | High-Temperature | | sive |
| Sample Number | weight) | weight) | (mAh) | Evaluation | 100 cycles (%) | Evaluation | Evaluation |
| Example 1 | 0.3 | 0.3 | 265.3 | ◯ | 90.1 | ◯ | ◯ |
| Example 2 | 0.5 | 0.5 | 264.2 | ◯ | 94.6 | ⊙ | ⊙ |
| Example 3 | 0.5 | 1.0 | 262.7 | ◯ | 95.0 | ⊙ | ⊙ |
| Example 4 | 0.5 | 2.0 | 243.7 | Δ | 92.9 | ⊙ | ◯ |
| Example 5 | 1.0 | 0.5 | 263.1 | ◯ | 95.5 | ⊙ | ⊙ |
| Example 6 | 1.0 | 1.0 | 257.0 | ◯ | 95.8 | ⊙ | ⊙ |
| Example 7 | 1.0 | 2.0 | 242.2 | Δ | 93.5 | ⊙ | ◯ |
| Example 8 | 1.5 | 0.5 | 261.0 | ◯ | 94.2 | ⊙ | ⊙ |
| Example 9 | 1.5 | 1.0 | 255.3 | ◯ | 96.0 | ⊙ | ⊙ |
| Example 10 | 1.5 | 2.0 | 240.1 | Δ | 96.3 | ⊙ | ◯ |
| Example 11 | 3.0 | 2.0 | 235.0 | Δ | 97.2 | ⊙ | ◯ |
| Comparative | 0.0 | 0.0 | 266.6 | ◯ | 78.5 | X | X |
| Example 1 | | | | | | | |
| Comparative | 0.3 | 0.0 | 266.4 | ◯ | 80.2 | Δ | Δ |
| Example 2 | | | | | | | |
| Comparative | 1.0 | 0.0 | 267.2 | ◯ | 82.3 | Δ | Δ |
| Example 3 | | | | | | | |
| Comparative | 3.0 | 0.0 | 257.3 | ◯ | 84.9 | Δ | Δ |
| Example 4 | | | | | | | |
| Comparative | 0.0 | 0.3 | 266.3 | ◯ | 81.5 | Δ | Δ |
| Example 5 | | | | | | | |
| Comparative | 0.0 | 1.0 | 260.3 | ◯ | 83.9 | Δ | Δ |
| Example 6 | | | | | | | |
| Comparative | 0.0 | 2.0 | 244.2 | Δ | 91.3 | ◯ | Δ |
| Example 7 | | | | | | | |

It is determined from the results shown in Table 1 that in the case of Examples 1 to 11, the addition of lithium bis(oxalate)borate and lithium difluoro(bisoxalato)phosphate, specifically, the lithium bis(oxalate)borate and the lithium difluoro(bisoxalato)phosphate added respectively at 0.3 parts by weight or more and 3.0 parts by weight or less and at 0.3 parts by weight or more and 2.0 parts by weight or less to 100 parts by weight of the non-aqueous electrolyte solution, can thereby improve the capacity retention rate after the repetition of a charge/discharge cycle at a high temperature, that is, the high-temperature cycle characteristics.

In addition, it is determined that in the case of Examples 2, 3, 5, 6, 8, and 9, the lithium bis(oxalate)borate and the lithium difluoro(bisoxalato)phosphate added respectively at 0.5 parts by weight or more and 1.5 parts by weight or less and at 0.5 parts by weight or more and 1.0 parts by weight or less to 100 parts by weight of the non-aqueous electrolyte solution, can thereby further improve the high-temperature cycle characteristics.

The embodiments and examples disclosed herein are to be considered by way of example in all respects, not restrictive. The scope of the present invention is defined by the claims, rather than the embodiments or examples described above, and intended to encompass all modifications and changes within the spirit and scope equivalent to the claims.

According to the present invention, in the case of a non-aqueous electrolyte secondary battery including a non-aqueous electrolyte solution containing a non-aqueous solvent and an electrolyte, the composition of an additive to the non-aqueous electrolyte solution can be provided for the improvement of the capacity retention rate after the repetition of a charge/discharge cycle at a high temperature, and the present invention can be thus applied to a non-aqueous electrolyte secondary battery with an additive contained in a non-aqueous electrolyte solution.

1. A non-aqueous electrolyte secondary battery comprising:
a non-aqueous electrolyte solution containing a non-aqueous solvent and an electrolyte, wherein at least two types of lithium salts with an oxalato complex as an anion are contained in the non-aqueous electrolyte solution.

2. The non-aqueous electrolyte secondary battery according to claim 1, wherein the at least two types of lithium salts are Li[M(C₂O₄)ₓR_{y}], and wherein
M is one selected from the group consisting of P, B, Al, Si, and C;
R is one group selected from the group consisting of a halogen group, an alkyl group, and a halogenated alkyl group;
x is a positive integer; and
y is 0 or a positive integer).

3. The non-aqueous electrolyte secondary battery according to claim 2, wherein the at least two types of lithium salts are lithium bis(oxalate)borate and lithium difluoro(bisoxalato)phosphate.

4. The non-aqueous electrolyte secondary battery according to claim 3, wherein the lithium bis(oxalate)borate and the lithium difluoro(bisoxalato)phosphate are contained respectively at 0.3 parts by weight or more and 3.0 parts by weight or less and at 0.3 parts by weight or more and 2.0 parts by weight or less to 100 parts by weight of the non-aqueous electrolyte solution.

5. The non-aqueous electrolyte secondary battery according to claim 3, wherein the lithium bis(oxalate)borate and lithium difluoro(bisoxalato)phosphate are contained respectively at 0.5 parts by weight or more and 1.5 parts by weight or less and at 0.5 parts by weight or more and 1.0 parts by weight or less to 100 parts by weight of the non-aqueous electrolyte solution.

6. The non-aqueous electrolyte secondary battery according to claim 1, wherein a first of the at least two types of lithium salts is contained at 0.3 parts by weight or more and 3.0 parts by weight or less to 100 parts by weight of the non-aqueous electrolyte solution, and a second of the at least two types of lithium salts is contained at 0.3 parts by weight or more and 2.0 parts by weight or less to 100 parts by weight of the non-aqueous electrolyte solution.

7. The non-aqueous electrolyte secondary battery according to claim 1, wherein a first of the at least two types of lithium salts is contained at 0.5 parts by weight or more and 1.5 parts by weight or less to 100 parts by weight of the non-aqueous electrolyte solution, and a second of the at least two types of lithium salts is contained at 0.5 parts by weight or more and 1.0 parts by weight or less to 100 parts by weight of the non-aqueous electrolyte solution.

8. The non-aqueous electrolyte secondary battery according to claim 1, wherein the non-aqueous solvent is selected from the group consisting of one or more of dimethyl carbonate, ethylmethyl carbonate, ethylene carbonate, propylene carbonate, butylene carbonate, and diethyl carbonate.

9. The non-aqueous electrolyte secondary battery according to claim 1, wherein the electrolyte is selected from the group consisting of one or more of LiPF₆, LiAsF₆, LiBF₄, LiCF₃SO₃, LiC(SO₂CF₃)₃, LiN(SO₂C₂F₅)₂, and LiN(SO₂CF₃)₂.
